(19) United States
(12) Patent Application Publication
(10) Pub. No.: US 2012/0231833 A1
(43) Pub. Date: Sep. 13, 2012

(54) Transmission Power Control

(76) Inventors: Troels Emil Kolding, Klarup (DK); Klaus Ingemann Pedersen, Aalborg (DK); Jacek Gora, Wroclaw (PL)

(21) Appl. No.: 13/504,731

(22) PCT Filed: Oct. 29, 2009
(86) PCT No.: PCT/EP09/64242

§ 371 Date: May 21, 2012

(51) Int. Cl. H04W 52/04

(52) U.S. Cl. 455/522

(57) ABSTRACT

There is provided solution for controlling transmission power characteristics of a local area base station. The solution includes determining the level of radio interference on a first frequency band used by a local area base station and on at least one second frequency band adjacent to the first frequency band. The solution may further comprise controlling the transmission power characteristics of the local area base station by taking into account at least one of the determined levels of interference.

### FIELD

The invention relates generally to mobile communication networks. More particularly, the invention relates to interference in a communication network of femtocells co-existing within a larger cell.

### BACKGROUND

In radio communication networks, such as the Long Term Evolution (LTE) or the LTE-Advanced (LTE-A) of the 3^{rd} Generation Partnership Project (3GPP), network planning comprises the use of wide area base stations (Node B, NB) accessible by all subscribers within a macro cell covered by the base station. However, it is not rare that certain environments are left without sufficient coverage even though they are located within the coverage area of the cell. These environments may include homes or offices, for example.

As a solution to provide sufficient coverage to this type of area, a femtocell is provided. A femtocell is generated by establishing a low power base station such as a local area base station (home Node B, hNB) in the area. The hNB provides coverage to a small area within the coverage area of the wide area base station. That is, a femtocell allows service providers to extend service coverage to areas where coverage would otherwise be limited or unavailable. A user terminal can, therefore, benefit from increased capacity by connecting to the hNB and communicating with it.

When hNBs are installed, for example in an uncoordinated manner, in an existing macro cell, means for controlling the transmit power of the hNB are necessary to ensure reliable wide area coverage on the macro layer while still ensuring a minimum performance level for users in the small femtocell. Current solutions for controlling the transmit power include measuring the received interference level from the macro layer and adjusting hNB's transmission power correspondingly. This solution, however, is rather limited solution for controlling the transmission power of the hNB. Accordingly, it is important to provide a solution for improving the control of the transmission power characteristics of the hNB within a larger cell.

### BRIEF DESCRIPTION OF THE INVENTION

Embodiments of the invention aim at improving the transmission power characteristics control of a local area base station coexisting with a wide area base station.

According to an aspect of the invention, there is provided a method as specified in claim 1.

According to an aspect of the invention, there are provided apparatuses as specified in claims 7, 13 and 14.

According to an aspect of the invention, there is provided a computer program product as specified in claim 15.

Embodiments of the invention are defined in the dependent claims.

### LIST OF DRAWINGS

In the following, the invention will be described in greater detail with reference to the embodiments and the accompanying drawings, in which

FIG. 1 presents a communication network employing private base stations, according to an embodiment;

FIG. 2 shows a communication network employing private base stations, according to an embodiment;

FIG. 3 shows a possible use of transmission powers on adjacent frequency bands;

FIG. 4 illustrates a method of controlling transmission power characteristics according to an embodiment;

FIG. 5 illustrates a block diagram of an apparatus according to an embodiment; and

FIG. 6 shows a method of controlling transmission power characteristics according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Although this invention is described using LTE (or Evolved universal mobile telecommunications system (UMTS) terrestrial radio access network (UTRAN)) as a basis, it can be applicable to any other wireless mobile communication systems as well. For example, the embodiments may be applied under the UMTS or the Global system for mobile communications (GSM), etc. The telecommunication system may have a fixed infrastructure providing wireless services to subscriber terminals.

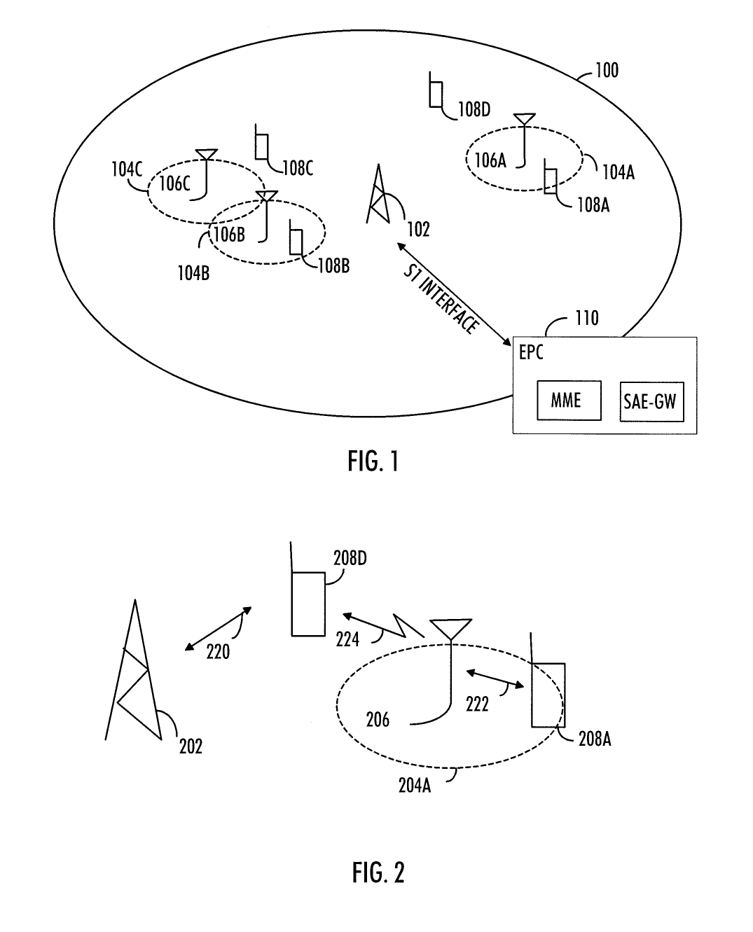

FIG. 1 shows a communication network employing private base stations, according to an embodiment. The communication network may comprise a public base station 102. The public base station 102 may provide radio coverage to a cell 100, control radio resource allocation, perform data and control signaling, etc. The cell 100 may be a macrocell, a microcell, or any other type of cell where radio coverage is present. Further, the cell 100 may be of any size or form depending on the antenna aperture.

The public base station 102 may be configured to provide communication services according to at least one of the following communication protocols: Worldwide Interoperability for Microwave Access (WiMAX), Universal Mobile Telecommunication System (UMTS) based on basic wideband-code division multiple access (W-CDMA), high-speed packet access (HSPA), long-term evolution (LTE), and/or LTE advanced (LTE-A). The public base station 102 may additionally provide the second generation cellular services based on GSM (Global System for Mobile communications) and/or GPRS (General Packet Radio Service). The present invention is not, however, limited to these protocols.

The public base station may be used by multiple network operators in order to provide radio coverage from multiple operators to the cell 100. The public base station 102 may also be called an open access base station or a common base station. The public base station 102 may also be called a wide area (WA) base station due to its broad coverage area. The wide area base station 102 may be a node B, an evolved node B (eNB) as in LTE-A, a radio network controller (RNC), or any other apparatus capable of controlling a radio communication and managing radio resources within the cell 100. The WA base station 102 may also have effect on mobility management by controlling and analyzing the radio signal level measurements performed by a user equipment, carrying out own measurements and performing handover based on the measurements.

For the sake of simplicity of the description, let us assume that the WA base station is an eNB. The development of E-UTRAN is concentrated on the eNB 102. All radio functionality is terminated here so that the eNB is the terminating point for all radio related protocols. The E-UTRAN may be configured such that an orthogonal frequency division multiple access (OFDMA) is applied in downlink transmission, whereas a single carrier frequency division multiple access (SC-FDMA) may be applied in uplink, for example. In the case of multiple eNBs in the communication network, the eNBs may be connected to each other with an X2 interface as specified in the LTE.

The eNB 102 may be further connected via an S1 interface to an evolved packet core (EPC) 110, more specifically to a mobility management entity (MME) and to a system architecture evolution gateway (SAE-GW). The MME is a control plane for controlling functions of non-access stratum signaling, roaming, authentication, tracking area list management, etc., whereas the SAE-GW handles the user plane functions including packet routing and forwarding, E-UTRAN idle mode packet buffering, etc. The user plane bypasses the MME plane directly to the SAE-GW. The SAE-GW may comprise two separate gateways: a serving gateway (S-GW) and a packet data network gateway (P-GW). The MME controls the tunneling between the eNB and the S-GW, which serves as a local anchor point for the mobility between different eNBs, for example. The S-GW may relay the data between the eNB and the P-GW, or buffer data packets if needed so as to release them after an appropriate tunneling is established to a corresponding eNB. Further, the MMEs and the SAE-GWs may be pooled so that a set of MMEs and SAE-GWs may be assigned to serve a set of eNBs. This means that an eNB may be connected to multiple MMEs and SAE-GWs, although each user terminal is served by one MME and/or S-GW at a time.

According to an embodiment, there are one or more femtocell radio coverage areas 104A to 104C within the cell 100. The one or more femtocell radio coverage areas 104A to 104C may be covered with radio access by corresponding one or more private base stations 106A to 106C, also known local area base stations or local base stations in the network. These base stations may be installed within buildings to provide additional coverage and capacity in homes and offices. Main targets of these techniques are to minimize the need for network configuration and enable new types of communications networks, such as decentralized ad hoc networks. The techniques enable self-tuning and reconfiguration of network parameters of the LA base stations. In addition, the techniques provide some solutions for utilizing and sharing spectrum resources among communication systems of the same or different operators serving in an overlapping or even common spectrum and/or geographical area.

The local area base stations may also be called private access points, closed access base stations, private base stations, or the like. In E-UTRAN these local area base stations are referred to as home node Bs (hNB). The one or more hNBs 106A to 106C provide radio coverage to the one or more femtocell radio coverage areas 104A to 104C. The hNB 106A to 106C may be any apparatus capable of providing coverage and controlling radio communication within the cell 104A to 104C. However, the hNB 106A to 106C differs from the eNB 102 such that the hNB 106A to 106C may be installed by a private user. Typically, the hNB 106A to 106C provides radio coverage to a smaller cell area than the eNB 102.

The hNBs 106A to 106C may be set up, for example, by an end user of a mobile communication network, such as a subscriber of a network provider. Accordingly, they may be set up in an ad-hoc or uncoordinated manner. The hNBs 106A to 106C may be, for example, in an active state, a sleep mode, a transition state, they may be switched off, or the like. The hNBs 106A to 106C may be switched off by anyone who has access to the hNBs 106A to 106C, for example the private users that have set up the hNBs 106A to 106C. Even though the end user may manually switch on the hNB 106A to 106C, the hNB 106A to 106C may automatically configure itself without any kind of manual intervention. Further, the hNBs 106A to 106C are independent of each other such that if the hNB 106A, for example, is in an active state, the hNB 106C may be switched off.

Similarly as the eNB 102, the hNBs 106A to 106C may be connected to and controlled by the EPC 110 of the network provider even though not shown in FIG. 1. That is, the eNB 102 may be part of the network planning of the operator, whereas the HNBs 106A to 106C may be deployed without any network planning. The connection between the hNB 106A to 106C and the EPC may be accomplished via the S1 interface. The connection from the hNB 106A to 106C to the EPC may be direct or it may contain a hNB gateway between the hNB 106A to 106C and the EPC. The hNB 106A to 106C may be moved from one geographical area to another and therefore it may need to connect to a different hNB gateway depending on its location. Further, the hNBs 106A to 106C may connect to a service provider's network via a broadband (such as DSL), etc.

According to an embodiment, either the eNB 102 or the hNB 106A to 106C may establish a connection with a user terminal (UT) 108A to 108D such as a mobile user terminal, a palm computer, user equipment or any other apparatus capable of operating in a mobile communication network. That is, the UT 108A to 108D may perform data communication with the eNB 102 or one of the hNBs 106A to 106C. If the UT 108A to 108D is located in a femtocell radio coverage area 104A to 104C, it may be connected to the corresponding hNB 106A to 106C. However, even though the UT 108A to 108D is located in a femtocell radio coverage area 104A to 104C, it may be connected to the eNB 102 instead of the corresponding hNB 16A to 106C. If the UT 108A to 108D is located outside the femtocell radio coverage areas 104A to 104C, the UT 108A to 108D may be connected to the eNB 102. However, the UT 108A to 108D may also be in a sleep mode or an idle mode, that is, it may not be connected to any base station. The broad term “base station” throughout the application denotes either the wide area base station 102 or a local area base station 106A to 106C.

FIG. 2 illustrates a communication network according to an embodiment. In the embodiment, eNB 202 offers radio connectivity to UTs 208A and 208D. Within the cell of the eNB 202, there exists a hNB 206 providing radio connectivity to a cell 204A. Let us assume that the UT 208D and eNB 202 have established a radio communication link 220 between each other, whereas the UT 208A is connected to the hNB 206 via a communication link 222. The established communication links 220 and 222 may be used for uplink or downlink data transfer. The radio links 220 and 22 may be on the same carrier frequency or they may be on different carrier frequencies. For example, when the radio links 220 and 222 are on the same carrier frequency, the transmission on the link 222 may cause interference on the link 220, and vice versa, as shown with a reference 224. This is especially the case when the UTs 208A and 208D are located relatively close to each other.

Moreover, when the radio links 220 and 222 are not performing data communication on the same frequency band but on the adjacent frequency bands, the transmission power on the other band 220 or 222 may leak to the adjacent band causing radio interference to the adjacent link 222 or 220, respectively.

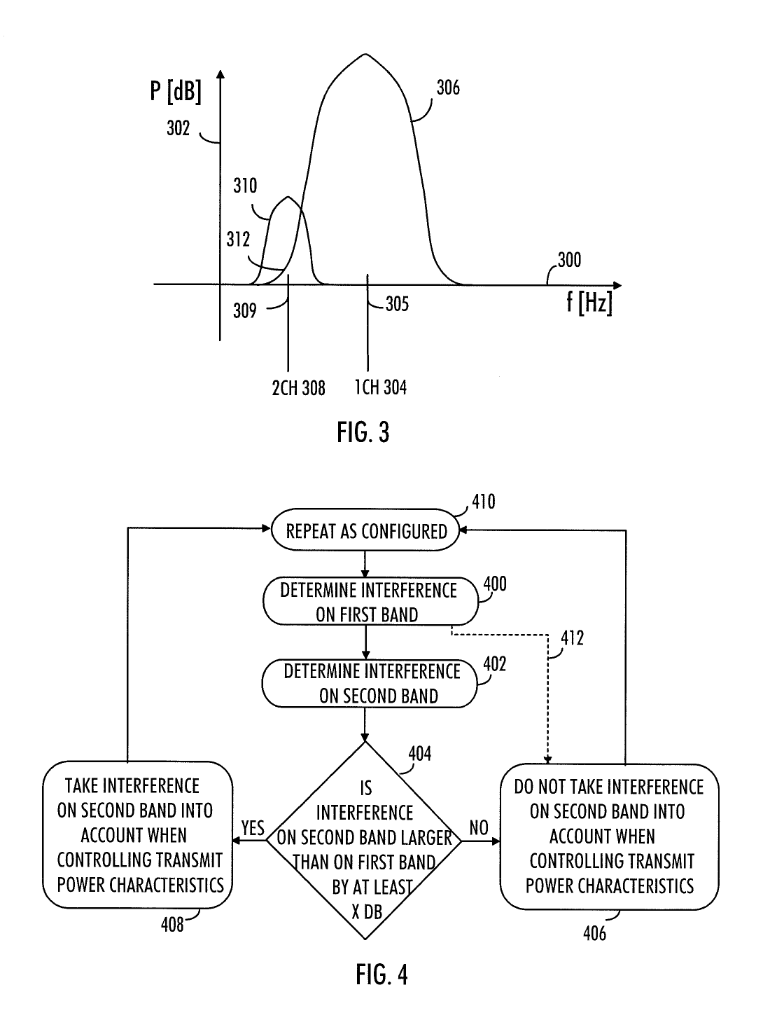

This is shown with reference to FIGS. 2 and 3. Let us assume that the radio link 222 between the hNB 206 and the UT 208A is established on a first channel 304 having a center frequency at point 305 on the frequency axis 300. Similarly, the radio link 220 between the eNB 202 and the UT 208D is established on a second channel 308 having a center frequency at point 309 on the frequency axis 300 and being adjacent to the first channel. The y-axis 302 represents the level of applied transmission power in dBs. A reference numeral 306 shows the transmission power distribution on the first channel 304, whereas a reference numeral 310 shows the transmission power distribution on the second channel 308. It may be that the maximum transmission power on one channel, for example on the first channel 304, is significantly higher than the transmission power on the second channel 308. This means that the radio link 222 is operating with higher transmit power than the radio link 220. When this happens, the transmission power 306 on the frequency band 304 of the radio link 222 may leak to the adjacent frequency band 308 of the radio link 220. Reference 312 shows that the transmission power 306 may leak to the other band, thereby causing undesired interference to the radio communication taking place on the radio link 220.

In the initial power control determination, the maximum allowed transmission power of the hNB 206, for example, is adjusted as a function of the path gain obtained from the eNB 202 which provides the strongest signal on the same carrier as the hNB 206. The path gain parameter may be indicated by other propagation related parameters such as path (propagation) loss or the like. The initial determination of the power control may result in setting the maximum allowed transmission power relatively low for those hNBs who have measured low path gains (high propagation losses). If the eNB 202 is not interfering with a high power, then the transmission power of the hNB 206 does not need to be excessively high. According to an embodiment, the maximum allowed transmission power may be further controlled if there is interference also on the adjacent carrier 309, as will be described below.

A solution for controlling the transmission power characteristics of a local area base station is provided as shown in FIG. 4. According to an embodiment, the level of radio interference on a first frequency band 304 used by a local area base station 206 is determined in step 400. The level of radio interference may be, for example, the strength of a strongest interfering signal, or some other parameter that can be used to indicate the existence of an interferer on the frequency band 304 under observation. That is, the received interference on the carrier 305 coming from an interfering source, such as the eNB 202, or from other radio transmitter, may be assessed. The assessment may be done by receiving different interfering signals and observing the levels of them. Further, noticing an increase in a noise level, monitoring interfering bursts on the observed frequency band 304, monitoring a power-frequency spectrum of the frequency band 304, etc., may provide information on the level of the interference. The total level of interference is necessarily not measured but a specific indication of the interference is determined instead. The indication may be a certain standardized parameter, for example. Further, as an example, the strongest interfering carrier on the frequency band under observation may be determined, or the cumulative interference of many interfering sources if present on the frequency band under observation.

The information embedded in the interfering signal may be user data transmitted on a carrier at frequency 309 from the eNB 202 to the UT 208D, for example. In other words, the carrier operating over radio link 220 may be causing interference to the radio link 222, especially when the UTs 208A and 208D are located close to each other. The hNB 206 may use the band 304 by transmitting/receiving data on a carrier operating at a frequency 305 corresponding to the first channel 304.

According to an embodiment, the level of radio interference on at least one second frequency band 308 adjacent to the first frequency band 304 is determined in step 402. The adjacent second band 308 denotes the frequency band next to the first band 304 on the frequency axis 300, when the frequency axis 300 is at least virtually divided into a plurality of frequency blocks used for data transmission. Thus, the level of interference, such as the strongest carrier strength and/or some other parameters, on at least one adjacent carrier 309 is assessed. The interference may be determined, for example, on the second channel 308 located around the carrier frequency 309, the channel 308 being adjacent to the first channel 304. Also the frequency band on the other side of the first channel 304 than the channel 308 may be observed to determine the level of interference on that band, although not shown in FIG. 3.

On the adjacent band 308 the interference may be caused by the high transmission power of the carrier 305 operating on the first channel 304, as explained earlier. That is, adjacent carrier interference may be present. This may especially be the case when the first frequency band 304 is reserved for a carrier 305 dedicated to the local area base station (the hNB 206). An operator of the network may indeed dedicate a carrier for the use of hNB 206. In that case there may be no interference determined in step 401. As a consequence, there may be no reason for the hNB 206 not to increase the transmission power so as to optimize the performance of the corresponding femtocell. As a consequence, the UT 208D performing communication with the eNB 202 on the adjacent band 308 may suffer from interference caused by the high transmit power on the band 304 leaking to the carrier frequency 309 used by the UT 208D. For example, the UT 208D camping on a wide area carrier 309 and being close to hNB 206 operating on its own carrier in an adjacent band 304, may see a signal difference in signal strengths between the femtocell area and the wide macro area of up to 50 dB. Such differences may not be handled by existing specified requirements for adjacent channel leakage and filtering. In addition, increasing the spurious emission requirements for the hNBs is not an attractive option since the hNBs are based on a very low-cost assumption.

However, a significant difference in transmission power may occur even when the carrier 305 used by the hNB 206 is operating at the same carrier frequency as the eNB 202, that is, the carrier 305 is not reserved for the use of the hNB 206 alone.

According to an embodiment, the radio interference on the first band 304 and/or on the second band 308 may be caused by at least one other local area base station. The at least one other local area base station may be located relatively close to the hNB 206 so that the interference may be an important factor to consider. Further, the interfering source may be a wide area base station.

According to an embodiment, the comparison of whether the interference is stronger on the at least one second band 308 than on the first band 304 is performed in step 404. The comparison is therefore done for the levels of interference determined in steps 400 and 402. For example, the strength of the interfering signals may be measured on power (P) domain in decibels for both channels 304 and 308, and in step 404 it may be determined whether the strength of the interfering signal is higher on the second band 308 than on the first band 304. The interference on either of the channels 304 and 308 may be caused by an eNB 202, another hNB, or any other apparatus providing electromagnetic radiation.

According to an embodiment, the comparison in step 404 may further determine whether the interference on the at least one second band 308 is stronger than on the first band 304 by at least X dB. The X dB is a predetermined threshold and the value of X may be a variable parameter or a fixed constant. More specifically, the value of X may be preconfigured at the hNB 206 or it may be signaled to the hNB 206 by an eNB 202. An exemplary value for the predetermined threshold may be 25 dB. However, if the interference is measured with other parameter than the strength of the interfering signal in dBs, the value and the unit of the predetermined threshold may not be 25 and dB, respectively, but other suitable values and units may be used. The comparison step in 404 with the predetermined threshold is advantageous since there is an inherent isolation between the carrier applied by the hNB 206 on the band 304 and the adjacent carrier that should be taken into account (e.g. due to adjacent carrier leakage requirements and RF filtering processes).

According to an embodiment, if the interference on the adjacent band 308 is not at least X dB stronger than the strongest interfering carrier on the channel 304 used by the hNB 206, then the transmission power characteristics of the hNB 206 are adjusted such that the interference on the second band 304 is not taken into account. That is, if the answer to the comparison performed in step 404 is negative, then step 406 takes place. The step 406 stipulates that the interference on the second band 308 is not taken into account when controlling the transmit power of the hNB 206. In other words, the transmission power characteristics of the hNB 206 are controlled on the basis of the level of interference on the first band 304, determined in step 400.

Controlling the transmission power characteristics on the basis of the first band interference may denote for example that when the interference on the first band 304 is high (e.g., the eNB 202 is communicating with a UT on the same carrier with high transmission power), the hNB 206 may increase its transmission power in order to enable better communication performance for the UT 208A communicating with the hNB 206. Even if the transmission power of the hNB 206 is increased, the interference caused to the communication between the eNB 202 and the UT operating on the same carrier is not severely harmed since they are already operating with a relatively high power. On the contrary, when the interference on the first band 304 is relatively low (e.g., the eNB 202 is communicating with the UT on the same carrier with low transmission power), the hNB 206 may decrease its transmission power so as to prevent itself from interfering with the communication between the eNB 202 and the UT.

According to another embodiment, if the interference on the adjacent band 308 is at least X dB stronger than the interference on the channel 304, then the transmission power characteristics of the hNB 206 are adjusted by taking into account the interference on the adjacent band 308. The determined interference level may be the level of the strongest interfering carrier on the band under observation. That is, if the answer to the comparison performed in step 404 is positive, then step 408 takes place. In an embodiment, the level of interference on the first band 304 is lower than on the adjacent band 308 because the band 304 may be dedicated for the use of hNB 206. The hNB 206 may obtain information on how to control its transmission power characteristics by determining the level of interference on the second band 308. If there is interference on the second band 308, the band 308 is being used by another radio transmitter (possibly a eNB 202, another hNB, etc.) and therefore the hNB 206 may not apply as high transmit power as it would if there were no transmission on the second band 308. This is because high transmit power for carrier 305 may leak to the carrier 309, thereby causing interference. The reduction of the transmit power may be expressed as a factor or in dB.

In addition to the level of interference on the at least one second band 308, the interference on the first band 304 may be taken into account as well when controlling the transmission power characteristics of the hNB 206. This may be performed by applying a predetermined weighting factor to the determined level of interference of the at least one second band when controlling the transmission power characteristics of the local area base station. The level of interference on the first band 304 may then also be taken into account by applying a similar, but not necessarily the same, weighting factor to the level of interference on the first band 304. The weighting factor may be something between 0 and 1, for example. The value of the weighting factor may depend on various aspects including the frequency separation between the frequency channels 304 and 308, the out-of-band emission requirements, etc. The interferences on at least one of the bands 304 and 308 may be weighted before the transmission power characteristics are controlled. The control/adjustment of the transmission power or the maximum allowed transmission power, for example, may mean that the transmission power or the maximum allowed transmission power is decreased or increased, or the level of the maximum allowed transmission power is maintained without changing it.

Alternatively, the transmission power characteristics of the local area base station may be controlled solely on the basis of the level of radio interference on the at least one second frequency band 304. That is, the level of radio interference on the first band 304 may not be taken into account when controlling the transmission power characteristics of the hNB 206. In this case the adjacent carrier 309 interference substitutes the own-carrier 305 interference in the calculation of the to-be-used transmission power characteristics.

According to an embodiment, the transmission power characteristics of the hNB 206 are controlled by setting the maximum allowed transmission power for it. The maximum allowed transmission power is the power which is not exceeded during data transmission. Accordingly, as the transmission power characteristics are controlled as described above, the maximum allowed transmission power may be set by considering the determined interference levels on the bands 304 and 308. For example, the maximum allowed transmission power for the hNB 206 on band 304 may be reduced if there is interference present on the second band 308, because too high maximum allowed transmission power on band 304 may cause interference to the adjacent band 308. If there is no interference on the second band 308, the transmission power (the maximum allowed transmission power) of the first band 304 may be increased without causing interference to any communication on the second band 308.

The method shown in FIG. 4 may be repeated as configured according to step 410. According to an embodiment, the repeating may take place according to a predetermined rule. The rule may be time-based or event-based. With respect to the time-based reassessment, the reassessment may be carried out periodically according to a period which may be a static or a semi-static parameter. As an example of a semi-static period, the period may be different during office hours and outside the office hours. The period may be hard coded in the local area base station, for example. As an example of the event-based reassessment, the local area base station may monitor the communication environment, for example, the number of UTs in the area and the reassessment of the interference levels may be carried out upon a determined change in the number of UTs.

As a further example of the time-based rule, repeating of the determination of the interference on the first band 304 may take place after a first predetermined period, whereas repeating the determination of the level of radio interference on the at least one second frequency band 308 may take place after a second predetermined period. The first and the second periods may be the same, i.e. each time step 400 is performed, step 402 is also processed continuing with steps 404 and 406 or 408. However, the second predetermined period may be different than the first predetermined period. In case the first period is shorter than the second period, the dotted line 412 may be followed after step 400 if the second predetermined period is not yet fulfilled. In case the second predetermined period is shorter than the first predetermined period, the step 400 may be omitted and only steps 402 and 408 are performed, although not shown in FIG. 4.

At least one of the first and second periods may be preconfigured at the hNB 206. Further, the eNB 202 may signal the at least one of the first and second periods to the hNB 206 if required.

After the transmission power and/or the maximum allowed transmission power is/are determined as described above, the hNB 206 may cause data transmission with the determined transmission power not exceeding the maximum allowed transmission power.

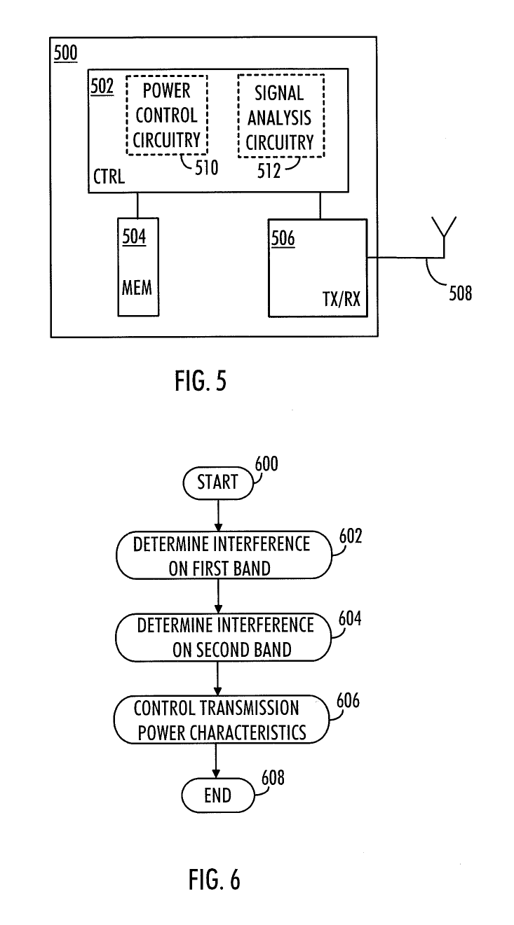

A very general architecture of an apparatus 500 for controlling the radio power of a local area base station, such as an hNB, according to an embodiment of the invention is shown in FIG. 5. FIG. 5 shows only the elements and functional entities required for understanding the apparatus 500 according to an embodiment of the invention. Other components have been omitted for reasons of simplicity. The implementation of the elements and functional entities may vary from that shown in FIG. 5. The connections shown in FIG. 5 are logical connections, and the actual physical connections may be different. It is apparent to a person skilled in the art that the apparatus 500 may also comprise other functions and structures.

The apparatus 500 for controlling the radio power of a local area base station may comprise a processor 502. The processor 502 may be implemented with a separate digital signal processor provided with suitable software embedded on a computer readable medium, or with separate logic circuit, such as an application specific integrated circuit (ASIC). The processor 502 may comprise an interface such as computer port for providing communication capabilities. The processor 502 may be, for example, a dual-core processor or a multiple-core processor.

The apparatus 500 may comprise a memory 504 connected to the processor 502. However, a memory may also be integrated into the processor 502 and, thus, the memory 504 may not be required. The memory 504 may be used to store, for example, the determined interference levels.

The apparatus 500 may further comprise a transceiver (TRX) 506. The TRX 506 may further be connected to one or more antennas 508 enabling connection to and from an air interface. The processor 502 may be configured to control radio power of data transmission. For example, the frequency of the transmission/reception, modulation and coding scheme and other operational parameters for the radio communication with terminal devices served by the local area base station. The processor 502 may also communicate with a wide area base station over a signaling connection.

According to an embodiment, the processor 502 determines the level of radio interference on a first frequency band used by the local area base station and determining the level of radio interference on at least one second frequency band adjacent to the first frequency band. When the processor 502 is determining the level of interference on a frequency band, the processor 502 may adjust the applied frequency to the corresponding frequency band so as to enable the transceiver 506 to receive signals at the desired frequency. From the received signals the processor 502 may determine the level of interference, such as the strongest interfering signal in dBs.

More specifically, the processor 502 may comprise a signal analysis circuitry 512 for analyzing the interference level on the frequency band under observation. The signal analysis circuitry 512 may estimate the received signals in terms of their reception powers. On the basis of the signal estimates, the signal analysis circuitry 512 may provide the value of the strongest interference at that carrier frequency. It may further identify the source of the interference on the basis of the physical layer identifiers or global identifiers, for example, which may be embedded in the received signals. As used in this application, the term ‘circuitry’ refers to all of the following: (a) hardware-only circuit implementations, such as implementations in only analog and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processor 502 may further control transmission power characteristics of the local area base station by taking into account the level of radio interference on the at least one second frequency band when the level of radio interference on the at least one second frequency band is higher than the level of radio interference on the first frequency band by at least a predetermined threshold. The processor 502 may calculate, for example, the maximum allowed transmission power of the hNB as explained above.

More specifically, the processor 502 may comprise a power control circuitry 510 for performing the transmission control. The power control circuitry 510 may control the power of a downlink transmission. For this purpose, the power control circuitry 510 may determine the downlink transmission power to be used and control transmitter parts 506 and 508 to apply the downlink transmission power in radio transmission. The transmission power may not exceed the maximum allowed transmission power calculated the basis of the method as shown in FIG. 4.

Alternatively according to another embodiment, the processor 502 may control the transmission power characteristics of the local area base station on the basis of the level of radio interference on the first frequency band when the level of radio interference on the at least one second frequency band is not higher than the level of radio interference on the first frequency band by the predetermined threshold.

Accordingly, there is proposed a mechanism for setting the transmission power characteristics for a hNB. The setting is based not only on own-carrier received interference but also on signal levels measured from adjacent carrier(s). The algorithm may be implemented in the hardware/software of the local area base station and the required parameters may be hard-coded or be communicated to the local area base station from other network architecture elements such as from the wide area base station (eNB) or from a server (for example, a hNB management server or a auto configuration server) for a semi-static implementation. Accordingly in FIG. 6, there is provided a method for controlling the radio power of a local area base station, such as an hNB. The method begins in step 600. In step 602 the level of radio interference on a first frequency band used by a local area base station is determined. Next, the level of radio interference on at least one second frequency band adjacent to the first frequency band is determined in step 604. In step 606 the transmission power characteristics of the local area base station are controlled by taking into account the level of radio interference on the at least one second frequency band when the level of radio interference on the at least one second frequency band is higher than the level of radio interference on the first frequency band by at least a predetermined threshold. Alternatively, the transmission power characteristics of the local area base station are controlled on the basis of the level of radio interference on the first frequency band when the level of radio interference on the at least one second frequency band is not higher than the level of radio interference on the first frequency band by the predetermined threshold. The method ends in step 608.

The embodiments of the invention offer many advantages. The transmission power characteristics of the local area base station may be adjusted in cases where interference is present on the adjacent carrier instead of the own carrier. By adjusting the transmission power, a leakage of power that interferes the communication on the adjacent carrier may be avoided. Therefore, the communication is more reliable for the user terminals in the communication network.

The techniques and methods described herein may be implemented by various means. For example, these techniques may be implemented in hardware (one or more devices), firmware (one or more devices), software (one or more modules), or combinations thereof. For a hardware implementation, the apparatus of FIG. 4 may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of the systems described herein may be rearranged and/or complemented by additional components in order to facilitate the achieving of the various aspects, etc., described with regard thereto, and they are not limited to the precise configurations set forth in the given figures, as will be appreciated by one skilled in the art.

Thus, according to an embodiment, the apparatus for performing the tasks of FIGS. 4 and 6 comprises processing means for determining the level of radio interference on a first frequency band used by a local area base station, processing means for determining the level of radio interference on at least one second frequency band adjacent to the first frequency band, and processing means for controlling transmission power characteristics of the local area base station by taking into account the level of radio interference on the at least one second frequency band when the level of radio interference on the at least one second frequency band is higher than the level of radio interference on the first frequency band by at least a predetermined threshold.

Embodiments of the invention may be implemented as computer programs in the apparatus according to the embodiments of the invention. The computer programs comprise instructions for executing a computer process for controlling the transmission power characteristics of a local area base station in downlink transmission. The computer program implemented in the apparatus may carry out, but is not limited to, the tasks related to FIGS. 4 and 6.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims. Further, it is clear to a person skilled in the art that the described embodiments may, but are not required to, be combined with other embodiments in various ways.

1. A method, comprising:
determining the level of radio interference on a first frequency band used by a local area base station;
determining the level of radio interference on at least one second frequency band adjacent to the first frequency band; and
controlling transmission power characteristics of the local area base station by taking into account the level of radio interference on the at least one second frequency band when the level of radio interference on the at least one second frequency band is higher than the level of radio interference on the first frequency band by at least a predetermined threshold.

2. The method of claim 1, further comprising:
controlling the transmission power characteristics of the local area base station on the basis of the level of radio interference on the first frequency band when the level of radio interference on the at least one second frequency band is not higher than the level of radio interference on the first frequency band by the predetermined threshold.

3. The method of claim 1, further comprising:
applying a predetermined weighting factor to the determined level of interference of the at least one second band when controlling the transmission power characteristics of the local area base station.

4. The method of claim 1, wherein the first frequency band is reserved for a carrier dedicated to the local area base station.

5. The method of claim 1, further comprising:
repeating the determination of the level of radio interference on the at least one second frequency band according to a predetermined rule.

6. The method of claim 1, further comprising:
adjusting the maximum allowed transmission power when controlling the transmission power characteristics.

7. An apparatus, comprising a processor configured to:
determine the level of radio interference on a first frequency band used by a local area base station;
determine the level of radio interference on at least one second frequency band adjacent to the first frequency band; and
control transmission power characteristics of the local area base station by taking into account the level of radio interference on the at least one second frequency band when the level of radio interference on the at least one second frequency band is higher than the level of radio interference on the first frequency band by at least a predetermined threshold.

8. The apparatus of claim 7, wherein the processor is further configured to:
control the transmission power characteristics of the local area base station on the basis of the level of radio interference on the first frequency band when the level of radio interference on the at least one second frequency band is not higher than the level of radio interference on the first frequency band by the predetermined threshold.

9. The apparatus of claim 7, wherein the processor is further configured to:
applying a predetermined weighting factor to the determined level of interference of the at least one second band when controlling the transmission power characteristics of the local area base station.

10. The apparatus of claim 7, wherein the first frequency band is reserved for a carrier dedicated to the local area base station.

11. The apparatus of claim 7, wherein the processor is further configured to:
repeat the determination of the level of radio interference on the at least one second frequency band according to a predetermined rule.

12. The apparatus of claim 7, wherein the processor is further configured to:
adjust the maximum allowed transmission power when controlling the transmission power characteristics.

13. An apparatus, comprising:
processing means for determining the level of radio interference on a first frequency band used by a local area base station;
processing means for determining the level of radio interference on at least one second frequency band adjacent to the first frequency band; and
processing means for controlling transmission power characteristics of the local area base station by taking into account the level of radio interference on the at least one second frequency band when the level of radio interference on the at least one second frequency band is higher than the level of radio interference on the first frequency band by at least a predetermined threshold.

14. An apparatus, comprising:
at least one processor and at least one memory including a computer program code, wherein the at least one memory and the computer program code are configured to, with the at least one processor, cause the apparatus at least to:
determine the level of radio interference on a first frequency band used by a local area base station;
determine the level of radio interference on at least one second frequency band adjacent to the first frequency band; and
control transmission power characteristics of the local area base station by taking into account the level of radio interference on the at least one second frequency band when the level of radio interference on the at least one second frequency band is higher than the level of radio interference on the first frequency band by at least a predetermined threshold.

15. A computer program product embodied on a distribution medium readable by a computer and comprising program instructions which, when loaded into an apparatus, execute the method according to claim 1.
